(19) United States
(12) Patent Application Publication
(10) Pub. No.: US 2011/0019213 A1
(43) Pub. Date: Jan. 27, 2011

(54) Toner saving method, toner saving system, and image forming apparatus

(75) Inventors: IIia Safonov, Moscow (RU); IIya Kurilin, Moscow (RU); IImir Alikberov, Moscow (RU); Sergey Yakovlev, Moscow (RU)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 12/659,662

(22) Filed: Mar. 16, 2010

(30) Foreign Application Priority Data
Jul. 23, 2009 (KR) 2009-0067278

(51) Int. Cl. H04N 1/60

(52) U.S. Cl. 358/1.9

(57) ABSTRACT

An image forming apparatus is provided. The present image forming apparatus includes a communication interface unit to receive a printing job, a parsing unit to parse the received printing job, a rendering unit to perform rendering by adding a hole to a random coordinate in a text character from the parsed printing job, and a printing engine unit to output the rendered image.

### CROSS-REFERENCE TO RELATED APPLICATIONS

This application claims the benefit of Korean Patent Application No. 2009-67278, filed in the Korean Intellectual Property Office on Jul. 23, 2009, the disclosure of which is incorporated herein by reference.

### BACKGROUND

1. Field

Aspects of the present invention relate to a toner saving method, a toner saving system, and an image forming apparatus, and more particularly, to a toner saving method which reduces the amount of ink or the number of dots of a toner consumed to print a text without compromising visual quality and thereby reduces consumption of a printer toner or an ink as less dots are printed, and a toner saving system and an image forming apparatus thereof.

2. Description of the Related Art

There are a lot of patent rights and documents related to reducing the amount of toner in a raster image processor (RIP) through special treatment of an overall rendered page bitmap. Generally, in order to reduce optical density of an overall image, printing is performed in a draft mode, that is, in a toner saving mode.

Reducing optical density in an electro-photographic printer or in an ink-jet printer is recognized as increasing pixel brightness prior to half-toning or screening or as converting a half-toning threshold. For instance, U.S. Pat. No. 5,646,670 discloses an apparatus and a method of reducing toner consumption by lowering the overall image density of a color image. U.S. Pat. No. 5,946,450 discloses a method for reducing toner or ink consumption in rendering images, in which a transfer function is used to modify screening of the image to be rendered. U.S. Pat. No. 6,476,836 discloses that image data having a pixel value larger than a predetermined threshold is converted into a predetermined pulse-width modulation (PWM) pattern, while, for the image data having a pixel value not larger than the predetermined threshold, no output is made.

However, if optical density is lowered for the overall image, the quality of a printed output may be significantly deteriorated as texts have rugged edges, text shape is not accurate, readability is poor, output text is not recognized in an optical character reader (OCR) occasionally, and the half-toned image is markedly distorted.

In order to improve a printed image and printed text, a method of preserving an edge pixel first and then lowering optical density of an internal area has been suggested. For instance, U.S. Pat. No. 5,483,625 discloses a method of preserving edge pixels while converting pixels according to a conventional pattern. U.S. Pat. No. 6,266,153 and United States Publication No. 2004/0190029 disclose a method of lowering optical density of an internal area only. The document printed following the above method may have improved quality, but holes inside characters form regular texture, which is very noticeable, printed texts are not recognized in an OCR application occasionally, and the half-toned image and gradient filled with areas are distorted, especially for color printing where color distortions are probable.

Therefore, the TrueType font has been proposed for toner saving, because of its holes, and uses 20% less ink than standard fonts. Ecofont may be convenient for office printing, but application of Ecofont has disadvantages: Ecofont supports only one font family for European languages based on Latin, Ecofont does not provide an appealing look on PC displays and does not look appealing on hardcopy for characters more than 30 pt, characters more than 30 pt are not recognized by OCR programs and the rate of toner saving is not adjustable.

The quality of documents printed in a toner saving mode of the above examples is inferior to that in a conventional mode, and it takes considerable calculation and cost to process the overall rendered page bitmap.

In addition, half-toned images and business graphics with gradients are suffered in first turn and text remains readable but its appearance is worse than solid black text. Furthermore, OCR application sometimes does not recognize such texts.

FIG. 1 illustrates examples of printed material according to various methods. Specifically, the text fragments illustrated in FIG. 1 are texts scanned at 600 DPI and magnified by 6 times. (a) in FIG. 1 shows printed material of which brightness of the overall image is enhanced by 25%, which means that half-toning has been performed in an electro-photographic and ink-jet printer. (b) in FIG. 1 shows printed material in which the edges of texts are preserved and the brightness of an internal area is enhanced by 25% according to a conventional technology. (c) in FIG. 1 shows the printed material of Ecofont. FIG. 1 shows that these modifications of characters are very noticeable by comparing (a) to (c) in FIG. 1 with an example of solid black text (e) in FIG. 1. (d) in FIG. 1 will be described later.

FIG. 2 is a flow chart illustrating a conventional toner saving method by processing overall page bitmap. The scheme is based on a processing pipeline in a RIP of standard printing protocols, Postscript and PCL. The bitmap contains dots for each color plane. The scheme is based on the processing pipeline in the RIP of standard printing protocols, Postscript and Printer Command Language (PCL), and texts are rasterized separately to each other. The method requires complicated calculation to perform font rendering from a vectorial description to a character bitmap for a standard font, such as TrueType and Typel. Therefore, postscripts and PCL RIPs use a font cache to store a character bitmap, and perform additional processing after rendering an overall page bitmap in order to save toner. Since the size of a page bitmap is enormous, it takes a lot of calculation to process the page bitmap.

In the method of FIG. 2, a printing job may be divided into a raster image, vector graphics, and a text character. Transformation and half-toning are performed on a raster image (201), rasterization is performed on vector graphics (202), and operations 203-206 are performed on a text character.

Whether a bitmap image regarding a text character exists in a font cache is determined (203). If it is determined that the bitmap image regarding the text character does not exist in the font cache, rasterization, in which vector graphics (vectorial text description) are converted into a raster image (pixel or dot) for printing and the size of a text character required in the vectorial description is converted into a character bitmap, is performed (204). The bitmap is stored in the font cache (205). The bitmap is extracted from the font cache (206). Individually-converted bitmaps are disposed in a page bitmap (207) and the page bitmap is additionally processed for toner saving (208). If it is determined that the bitmap image regarding the text character does exist in the font cache, the process moves directly from operation 203 to operation 206.

### SUMMARY

Aspects of the present embodiment relate to adding a small hole to a random coordinate in a character bitmap during font rendering before the character bitmap is stored in a font cache, thereby overcoming problems of conventional technologies.

Additional aspects and/or advantages will be set forth in part in the description which follows and, in part, will be apparent from the description, or may be learned by practice of the invention.

The foregoing and/or other aspects are achieved by providing a toner saving method, including: converting a font character into a character bitmap at a control unit, generating a random coordinate in the character bitmap at the control unit, comparing a first bitmap fragment F1 of the character bitmap having a predetermined size with reference to the random coordinate with a pre-stored first mask M1 with respect to the random coordinate at the control unit, and converting a second bitmap fragment F2 of the character bitmap including at least part of the first bitmap fragment F1 into a pre-stored second mask M2 when the first bitmap fragment is the same as the pre-stored first mask at the control unit, and storing the changed character bitmap at a storage unit.

The size of the first mask M1 and the second mask M2 may be determined according to a printing resolution.

The first mask M1 may be a bitmap image including non-edge parts.

The second mask M2 may include a plurality of round or oval holes.

The number of generated random coordinates may be determined according to the size of the character bitmap.

The foregoing and/or other aspects are achieved by providing a toner saving system, including a font rasterizer to receive a text parameter, such as a character code, a font, a matrix conversion and a text effect, rasterize the character code from a vectorial character description included in a font according to the text parameter, and generate a character bitmap, a random number generator to generate a random coordinate in the character bitmap, a hole adding module to receive the character bitmap from the font rasterizer, the random coordinate (x, y) in the character bitmap from the random number generator, masks M1, M2 according to a printing resolution, and a toner saving control ratio, and add holes to the random coordinate in the character bitmap, and a font cache to store the character bitmap to which holes are added.

The hole adding module may include an attenuation counter to receive an input count to start an operation of adding holes, a comparator to compare an output of the attenuation counter with ‘0’, an inverter to invert the output of the comparator and request a next random coordinate to the random number generator, a mask comparator to compare a first bitmap fragment F1 of the character bitmap having an intermediate point of (x, y) and a first size of (N1, N2) with the first mask M1, and a memory register to change a second bitmap fragment F2 of the character bitmap having the intermediate point of (x, y) and a second size of (K1, K2) to the second mask M2 when the output of the mask comparator is true.

The foregoing and/or other aspects are achieved by providing an image forming apparatus, including a communication interface unit to receive a printing job, a parsing unit to parse the received printing job, a rendering unit to perform rendering by adding holes to a random coordinate in a text character from the parsed printing job, and a printing engine unit to print an image rendered by the rendering unit.

The rendering unit may include a font rasterizer to convert the text character from the parsed printing job into a character bitmap, a random number generator to generate the random coordinate in the character bitmap, and a hole adding module to add holes to the random coordinate in the character bitmap.

The hole adding module may include a mask comparator to determine whether a first bitmap fragment F1 which is a part of the character bitmap is the same as a pre-stored first mask M1 and a memory register which converts a partial area F2 of the first bitmap fragment F1 into a second mask M2 including a pre-stored hole when it is determined that the first bitmap fragment F1 is the same as the first mask M1.

The first mask M1 and the second mask M2 may be determined by a printing resolution.

A size of the first mask M1 may be greater than a size of the second mask M2.

The first mask M1 may be a bitmap image including non-edge parts.

The second mask M may include a plurality of round or oval holes.

The random number generator may generate a plurality of random coordinates, and the hole adding module may add holes to each of the plurality of random coordinates.

The number of random coordinates generated by the random number generator may be determined by the size of the character bitmap.

The foregoing and/or other aspects are achieved by providing a toner saving method, including parsing a received printing job, rendering by adding a hole to a random coordinate in a text character from the parsed printing job, and printing the rendered image at a printing unit.

The rendering may include converting the text character from the parsed printing job into a character bitmap, generating the random coordinate in the character bitmap, and adding the hole to the random coordinate in the generated character bitmap.

The adding the hole may include comparing a first bitmap fragment F1 which is a part of the character bitmap with a pre-stored first mask M1 to determine whether the first bitmap fragment is the same as the first mask and converting a partial area F2 of the first bitmap fragment F1 into a second mask M2 including a pre-stored hole when it is determined that the first bitmap fragment F1 is the same as the first mask M1.

The second mask M2 may include a plurality of round or oval holes.

### BRIEF DESCRIPTION OF THE DRAWINGS

These and/or other aspects and advantages will become apparent and more readily appreciated from the following description of the embodiments, taken in conjunction with the accompanying drawings, of which:

FIG. 1 shows examples of printed material according to various methods;

FIG. 2 is a flow chart illustrating a conventional toner saving method which performs bitmap processing on an overall page;

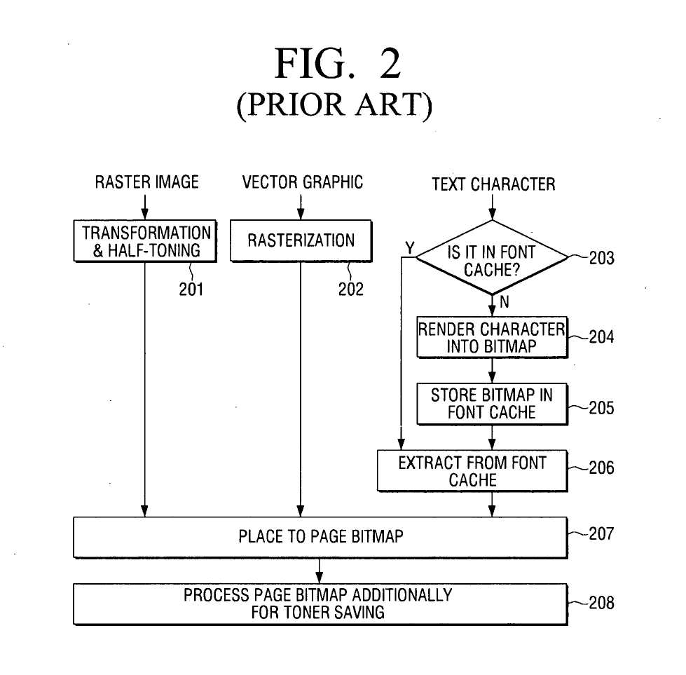

FIG. 3 is a flow chart illustrating a toner saving method according to an exemplary embodiment;

FIG. 4 is a flow chart illustrating a method of font rendering to save toner according to an exemplary embodiment;

FIG. 5 is a block diagram of a toner saving system according to an exemplary embodiment;

FIG. 6 is a detailed block diagram of a hole-adding module in FIG. 5, and

FIG. 7 is a block diagram of an image forming apparatus according to an exemplary embodiment.

### DETAILED DESCRIPTION

Reference will now be made in detail to the exemplary embodiments, examples of which are illustrated in the accompanying drawings, wherein like reference numerals refer to like elements throughout. The embodiments are described below, in order to explain the present invention by referring to the figures.

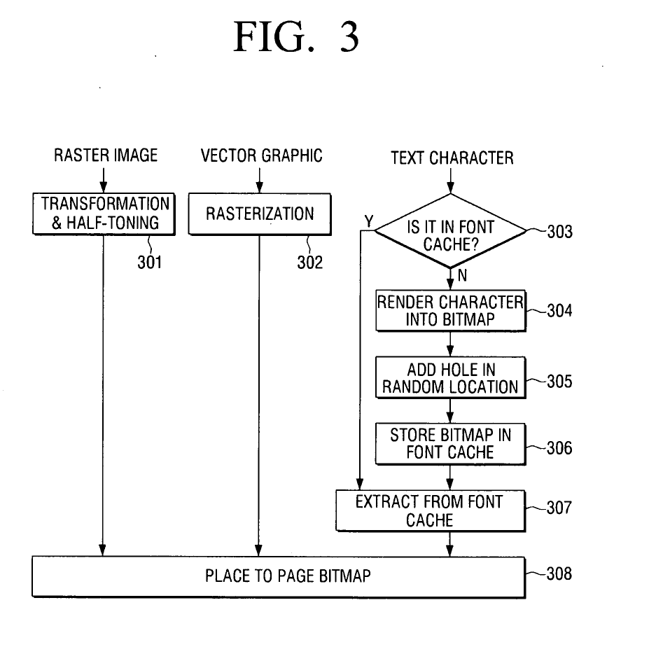

FIG. 3 is a flow chart illustrating a toner saving method according to an exemplary embodiment.

Referring to FIG. 3, parsing is first performed on a received printing job, and the parsed printing job may be divided into a raster image, vector graphics, and a text character as illustrated in FIG. 3. Transformation and half-toning are performed on a raster image(301), rasterization is performed on vector graphics (302), and operations 304, 305, and 306 are performed on a text character. Hereinafter, the processing operation regarding a text character will be described in detail.

Whether a bitmap image regarding a text character exists in a font cache is determined (303). If it is determined that the bitmap image regarding the text character does not exist in the font cache, rasterization is performed on the text character. Specifically, rasterization is converting vector graphics (vectorial text description) into a raster image (pixel or dot) for printing, and converting the size of a text character required in the vectorial description into a character bitmap (304).

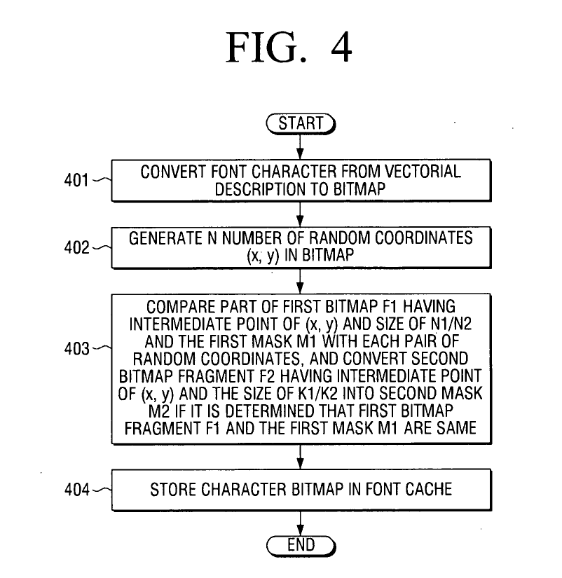

A hole is added to a random coordinate in the character bitmap (305). A detailed description regarding the operation of adding a hole to a bitmap will be provided later with reference to FIG. 4.

The bitmap to which a hole is added is stored in the font cache (306). The bitmap is extracted from the font cache (307). If it is determined that the bitmap image regarding the text character does exist in the font cache, the process moves directly from operation 303 to operation 307.

Individually-converted bitmaps are disposed in a page bitmap (308) and the disposed page bitmap may be printed. Since the operation of disposing bitmaps in the page bitmap and printing them is the same as described above, the description regarding this will be omitted.

FIG. 4 is a flow chart illustrating a method of font rendering to save toner according to an exemplary embodiment.

Referring to FIG. 4, a font character is converted into a bitmap (401). Specifically, a text character from among parsed printing jobs may be converted into a character bitmap with reference to the vectorial description. A random coordinate in a character bitmap is generated (402). Specifically, a random coordinate (x, y) in the character bitmap may be generated. The generated random coordinate may be plural, and the number of random coordinates may be changed according to the size of the character bitmap.

A hole may be added to the generated random coordinate in the character bitmap (403). Specifically, a first bitmap fragment F1 having the intermediate point of (x, y) and the size of (N1, N2), that is, a part of the character bitmap area (having a predetermined size with reference to a random coordinate (x, y)) and a pre-stored first mask M1 are compared, and if it is determined that the first bitmap fragment F1 and the first mask M1 are the same, a second bitmap fragment F2 having the intermediate point of (x, y) and the size of (K1, K2) (that is, a partial area of the first bitmap fragment F1) may be converted into a second mask M2 (403). The size of the first mask M1 and the second mask M2 may be changed according to the printing resolution, and it is desirable that the size of the first mask M1 is greater than that of the second mask M2. Meanwhile, the first mask M1 may be a bitmap image including non-edges, and the second mask M2 may be a bitmap image including a plurality of round or oval holes.

Then, a character bitmap to which a hole is added is stored in a font cache (404).

As described above, according to the present toner saving method, special processing is performed only on a text character, particularly on a given font and size, and thus processing can be performed rapidly. This is particularly remarkable with regard to a color image. Specifically, conventional technologies perform processing on several color panes, while the present embodiment performs a toner saving operation only on a bitmap of a rasterized character without deteriorating the quality of half-toned bitmap and vector graphics.

The toner saving ratio of the present embodiment is adaptively changed according to page contents, and in the case of a typical office document, the toner consumption is reduced by over 20%. The present embodiment is distinct from conventional technologies in that the present embodiment does not perform a toner saving operation on small fonts. Therefore, the quality of texts in small fonts can be maintained. In addition, since small holes within a character area are randomly disposed in the present embodiment, the appearance of the character is not so different from the printed material of a solid black text when toner saving is not performed.

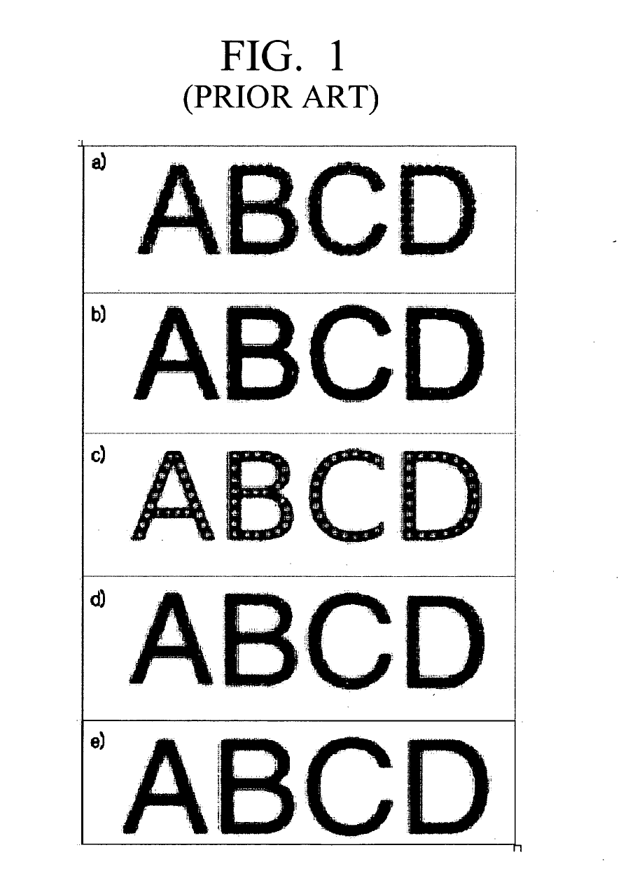

(d) in FIG. 1 illustrates an example of printed material according to an exemplary embodiment, and (e) in FIG. 1 illustrates an example of printed material of a solid black text when the toner saving mode is not performed. Comparing (d) and (e) in FIG. 1, one can see that there is no significant difference between the printed material of the present embodiment and the solid black text when the toner saving mode is not performed. Therefore, the small holes in the printed material of the present embodiment are recognizable only when they are looked at carefully. In addition to the toner saving ratio, character brightness can also be adjusted. Unlike Ecofont, the present embodiment is applicable to every language.

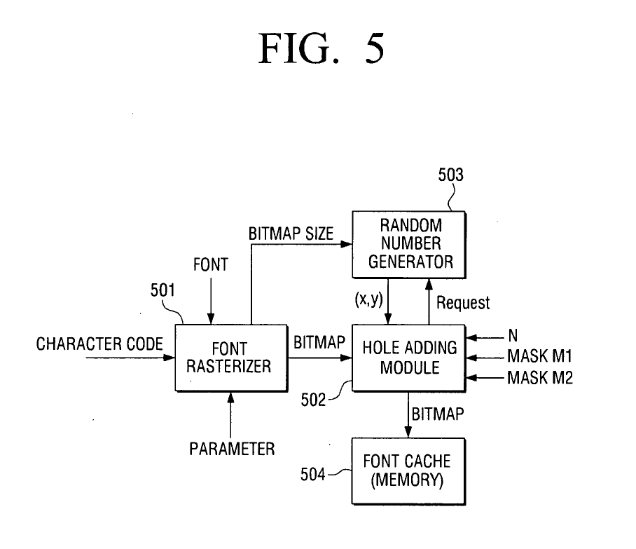

FIG. 5 is a schematic view illustrating a toner saving system according to an exemplary embodiment. As illustrated in FIG. 5, the toner saving system may be integrated into a printer or firmware in the RIP of a multifunction printer, and may be integrated as a separate electronic system.

Referring to FIG. 5, the present toner saving system may include a font rasterizer 501, a hole adding module 502, a random number generator 503, and a font cache 504.

The font rasterizer 501 rasterizes characters in a vectorial character description included in a font according to a text parameter, such as matrix transformation and text effect. Specifically, if a character code, a font, and a text parameter are input, the font rasterizer 501 transmits the rasterized bitmap to the hole adding module 502 and transmits the size of the rasterized bitmap to the random number generator 503.

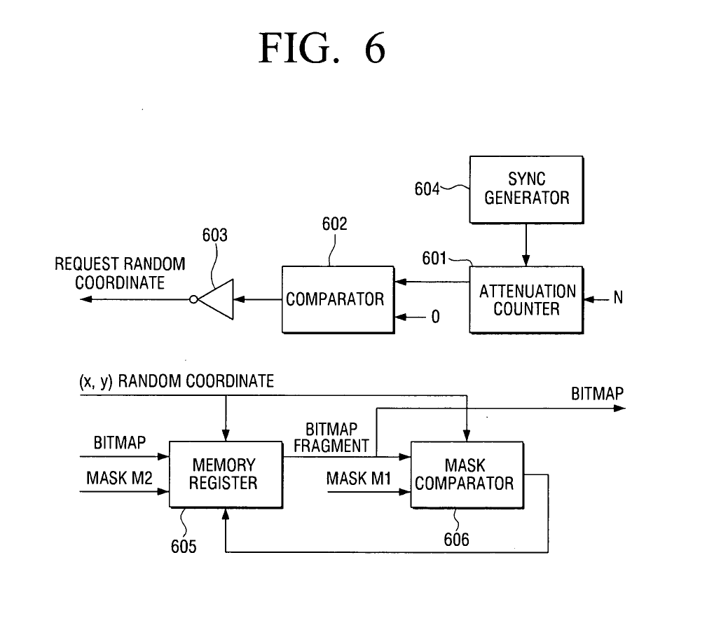

The hole adding module 502 adds holes to a random coordinate of a character bitmap. Specifically, the hole adding module 502 may receive a character bitmap from the font rasterizer 501, and receive a random coordinate (x, y) in the bitmap, mask M1, M2 according to a printing resolution, and toner saving ratio N. The hole adding module 502 may add small holes to a random coordinate in a character bitmap, request the random number generator 503 to generate a next random coordinate, and transmit the bitmap to which holes are added to the font cache 504. Detailed structure and operation of the hole adding module 502 will be explained later with reference to FIG. 6.

The random number generator 503 generates a random coordinate (x, y) in a character bitmap. Specifically, the random number generator 503 receives the size of a bitmap from the font rasterizer 501, generates the random coordinate (x, y) in the character bitmap according to the size of the bitmap, and transmits the random coordinate (x, y) to the hole adding module 502. The number of random coordinates generated from the random number generator 503 may be changed according to the size of the character bitmap. For instance, if the size of the character bitmap is big, the number of holes to be included in the character bitmap is also big, and thus more random coordinates can be generated. On the other hand, if the size of the character bitmap is small, the number of holes added to the character bitmap is limited, and thus the number of random coordinates may be small. If the size of the character bitmap is smaller than a predetermined size, the random number generator 503 may not generate a random coordinate so as not to add holes to the character bitmap. Accordingly, even the texts having small fonts may maintain excellent quality.

The font cache 504 stores a bitmap to which holes are added. Specifically, the font cache 504 is a memory which stores a render character bitmap with regard to a current page or a printing job.

FIG. 6 is a detailed view of the structure of a hole-adding module 502.

Referring to FIG. 6, the hole adding module 502 may include an attenuation counter 601, a comparator 602, an inverter 603, a sync generator 604, a memory register 605, and a mask comparator 606.

The attenuation counter 601 does N number of count downs, and requests the random number generator 503 to generate a random coordinate. The request is transmitted to the random number of generator 503 via the comparator 602 and the inverter 603. The number N represents a toner saving control ratio and the starting count value input to the attenuation counter 601. The number N may be changed according to the size of the character bitmap and corresponds to the number of random coordinates generated from the random number generator 503 as described above.

The sync generator 604 synchronizes the attenuation counter 601, and the comparator 602 compares the output of the attenuation counter 601 with ‘0’ and outputs the result. The inverter 603 may invert the output of the comparator 602 and transmit the output to the random number generator 503.

If the first bitmap fragment F1 is the same as the first mask M1, the memory register 605 may convert partial area F2 of the first bitmap fragment F1 to the second mask M2 including pre-stored holes. Specifically, the memory register 605 receives a signal of a character bitmap, the second mask M2, a random coordinate (x, y), and an output of a mask comparator 606. The memory register 605 may store the character bitmap and allocate a partial area of the character bitmap (having a predetermined size of (N1, N2) with respect to the random coordinate (x, y)) to the first bitmap fragment F1. If the signal from the mask comparator 606 is ‘1’ (true), the memory register 605 may change the second bitmap fragment including at least part of the first bitmap fragment F1 (having a predetermined size of (K1, K2) with respect to the random coordinate (x, y)) to the second mask M2. The first mask M1 and the second mask M2 may be changed according to a printing resolution. The first mask M1 may be a bitmap image including non-edges, and the second mask M2 may be a bitmap image including a plurality of round or oval holes. For instance, the first mask M1 at printing resolution 600 DPI may be as follows:

0 1 1 1 0

1 1 1 1 1

1 1 1 1 1

1 1 1 1 1

0 1 1 1 0

‘1’ represents a visible pixel and ‘0’ represents an invisible pixel. The second mask M2 may be as follows:

010

111

010

The mask comparator 606 may determine whether the first bitmap fragment F1 which is a partial area of a character bitmap is the same as the pre-stored first mask M1. Specifically, if the first bitmap fragment F1, the mask M1, and the random coordinate (x, y) are received, the mask comparator 606 may compare the first bitmap fragment F1 with the mask M1 and transmit the result to the memory register 605. The first bitmap fragment F1 is a partial area of the character bitmap having the predetermined size (N1, N2) with respect to the random coordinate (x, y).

Accordingly, the hole adding module 502 may randomly add small holes only to characters in a predetermined size. The hole adding module 502 may be integrated into a microprocessor system including a processor and a memory.

The seed of the random number generator 503 may be changed according to the size of a character bitmap. The ‘N’ input to the attenuation counter 601 may be the same as the number of random coordinate pairs which are generated repeatedly. Accordingly, a toner saving ratio may be adjusted by changing ‘N’. ‘N’ may be within a range of W/64˜2 W, and W represents the number of all pixels in a character pixel.

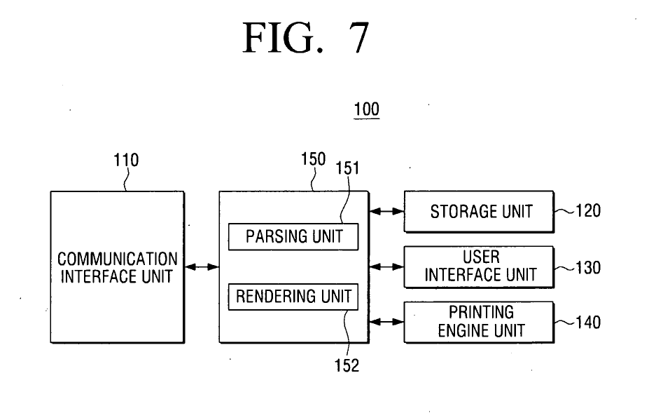

FIG. 7 is a block diagram illustrating the structure of the image forming apparatus 100 according to an exemplary embodiment. Referring to FIG. 7, the image forming apparatus 100 includes a communication interface unit 110, a storage unit 120, a user interface unit 130, a printing engine unit 140, and a control unit 150. The image forming apparatus 100 may be a multi function peripheral (MFP) which provides functions of a copy machine, a printer, a fax machine, and a scanner in a single apparatus.

The communication interface unit 110 is connected to a terminal apparatus (not shown), such as a PC, a notebook PC, a PDA, and a digital camera. Specifically, the interface unit 110 may be formed to connect the image forming apparatus 100 to an external apparatus, may be connected to a terminal apparatus via a local area network (LAN) and internet network, or may be connected via a universal serial bus (USB). The communication interface unit 110 may receive information regarding a printing job via a terminal apparatus (not shown), and may receive a printing operation type regarding the printing job.

The storage unit 120 may store a printing job received from the communication interface unit 110 temporarily, and may also store a rendered font image. That is, the storage unit 120 may serve as a font cache. The storage unit 120 may be embodied as a storage medium and an external storage medium in the image forming apparatus, for example, as a removable disk including a USB memory, a storage medium connected to a host, or a web server via a network, for example.

The user interface unit 130 includes a plurality of function keys or other interface options allowing a user to install or select various functions supported by the image forming apparatus 100, and displays various information provided by the image forming apparatus 100. The user interface unit 130 may be embodied as an apparatus which can input and output at the same time, such as a touch pad, or may be embodied as an apparatus which combines a mouse and monitor. A user may receive a print mode of a current printing job using an interface window provided via the user interface unit 130. Specifically, the printing mode of the current job may be received from a terminal apparatus (not shown) via the communication interface unit 110, and may be received directly from a user from the user interface unit 130 of the image forming apparatus 100.

The printing engine unit 140 performs a printing job input from the communication interface unit 110.

The control unit 150 converts an image input via the communication interface unit 110 to an image which can be output and transmits the converted image to the printing engine unit 140. Specifically, the control unit 150 may include a parsing unit 151 and a rendering unit 152.

The parsing unit 151 parses a received printing job. Specifically, the parsing unit 151 may distinguish a raster image, vector graphics, and a text character in the printing job by parsing the printing job received from the communication interface unit 110.

The rendering unit 152 may render a parsed printing job. Specifically, the rendering unit 152 may perform rendering (rasterization) on each printing job distinguished by the parsing unit 151 in an appropriate way for each printing job. The text character among the parsed printing jobs may be rendered by adding holes to a random coordinate in the text character. The rendering unit 152 may include the font rasterizer 501 to convert a parsed text into a character bitmap, the random number generator 503 to generate a random coordinate in a character bitmap, and the hole adding module 502 to add holes to a random coordinate in a character bitmap. The hole adding module 502 may include the mask comparator 606 to compare the first bitmap fragment F1 which is part of a character bitmap with the pre-stored first mask M1 and determine whether they are the same, and the memory register 605 which converts the partial area F2 of the first bitmap fragment F1 into the pre-stored second mask M2 if the first bitmap fragment F1 is the same as the pre-stored first mask M1. Detailed structure and operation of the rendering unit 152 and the hole adding module 502 have been described with reference to FIG. 5 and FIG. 6, and thus will be omitted.

As the present image forming apparatus 100 adds small holes to a random coordinate in a character bitmap, toner may be saved adaptively according to page contents without quality deterioration.

The embodiments can be implemented in computing hardware (computing apparatus) and/or software, such as (in a non-limiting example) any computer that can store, retrieve, process and/or output data and/or communicate with other computers. The results produced can be displayed on a display of the computing hardware. A program/software implementing the embodiments may be implemented by a computer and may be recorded on computer-readable media including computer-readable recording and/or storage media. Examples of the computer-readable recording media include a magnetic recording apparatus, an optical disk, a magneto-optical disk, and/or a semiconductor memory (for example, RAM, ROM, etc.). Examples of the magnetic recording apparatus include a hard disk device (HDD), a flexible disk (FD), and a magnetic tape (MT). Examples of the optical disk include a DVD (Digital Versatile Disc), a DVD-RAM, a CD-ROM (Compact Disc-Read Only Memory), and a CD-R (Recordable)/RW.

Further, according to an aspect of the embodiment, any combinations of the described features, functions and/or operations can be provided.

Although a few embodiments have been shown and described, it would be appreciated by those skilled in the art that changes may be made in this embodiment without departing from the principles and spirit of the invention, the scope of which is defined in the claims and their equivalents.

What is claimed is:

1. A toner saving method, comprising:
converting a font character into a character bitmap at a control unit;
generating a random coordinate in the character bitmap at the control unit;
comparing a first bitmap fragment of the character bitmap having a predetermined size with reference to the random coordinate with a pre-stored first mask with respect to the random coordinate at the control unit;
converting a second bitmap fragment of the character bitmap including at least part of the first bitmap fragment into a pre-stored second mask when the first bitmap fragment is the same as the pre-stored first mask at the control unit; and
storing the changed character bitmap at a storage unit.

2. The toner saving method as according to claim 1, wherein the sizes of the first mask and the second mask are determined according to a printing resolution.

3. The toner saving method as according to claim 1, wherein the first mask is a bitmap image including non-edge parts.

4. The toner saving method as according to claim 1, wherein the second mask includes a plurality of round or oval holes.

5. The toner saving method as according to claim 1, wherein a number of generated random coordinates is determined according to a size of the character bitmap.

6. A toner saving system, comprising:
a font rasterizer receiving a text parameter, rasterizing the character code from a vectorial character description included in a font according to the text parameter, and generating a character bitmap;
a random number generator generating a random coordinate in the character bitmap;
a hole adding module receiving the character bitmap from the font rasterizer, the random coordinate in the character bitmap from the random number generator, first and second masks according to a printing resolution, and a toner saving control ratio, and adding holes to the random coordinate in the character bitmap; and
a font cache store the character bitmap to which holes are added.

7. The toner saving system according to claim 6, wherein the hole adding module comprises:
an attenuation counter receiving an input count to start an operation of adding holes;
a comparator comparing an output of the attenuation counter with ‘0’;
an inverter inverting the output of the comparator and requesting a next random coordinate to the random number generator;
a mask comparator comparing a first bitmap fragment of the character bitmap having an intermediate point of and a first size with the first mask; and
a memory register changing a second bitmap fragment of the character bitmap having the intermediate point of and a second size of to the second mask when the output of the mask comparator is true.

8. An image forming apparatus, comprising:
a communication interface unit receiving a printing job;
a parsing unit parsing the received printing job;
a rendering unit performing rendering by adding holes to a random coordinate in a text character from the parsed printing job; and
a printing engine unit printing an image rendered by the rendering unit.

9. The image forming apparatus according to claim 8, wherein the rendering unit comprises:
a font rasterizer converting the text character from the parsed printing job into a character bitmap;
a random number generator generating the random coordinate in the character bitmap; and
a hole adding module adding holes to the random coordinate in the character bitmap.

10. The image forming apparatus according to claim 9, wherein the hole adding module comprises:
a mask comparator determining whether a first bitmap fragment which is a part of the character bitmap is the same as a pre-stored first mask; and
a memory register converting a partial area of the first bitmap fragment into a second mask including a pre-stored hole when it is determined that the first bitmap fragment is the same as the first mask.

11. The image forming apparatus according to claim 10, wherein the first mask and the second mask are determined by a printing resolution.

12. The image forming apparatus according to claim 10, wherein a size of the first mask is greater than a size of the second mask.

13. The image forming apparatus according to claim 10, wherein the first mask is a bitmap image including non-edge parts.

14. The image forming apparatus according to claim 10, wherein the second mask includes a plurality of round or oval holes.

15. The image forming apparatus according to claim 9, wherein the random number generator generates a plurality of random coordinates, and the hole adding module adds holes to each of the plurality of random coordinates.

16. The image forming apparatus according to claim 15, wherein the number of random coordinates generated by the random number generator is determined by the size of the character bitmap.

17. A toner saving method, comprising:
parsing a received printing job;
rendering by adding a hole to a random coordinate in a text character from the parsed printing job; and
printing the rendered image at a printing unit.

18. The toner saving method according to claim 17, wherein the rendering comprises:
converting the text character from the parsed printing job into a character bitmap;
generating the random coordinate in the character bitmap; and
adding the hole to the random coordinate in the generated character bitmap.

19. The toner saving method according to claim 18, wherein the adding the hole comprises:
comparing a first bitmap fragment which is a part of the character bitmap with a pre-stored first mask to determine whether the first bitmap fragment is the same as the first mask; and
converting a partial area of the first bitmap fragment into a second mask including a pre-stored hole when it is determined that the first bitmap fragment is the same as the first mask.

20. The toner saving method according to claim 19, wherein the second mask includes a plurality of round or oval holes.
